(19) United States
(12) Patent Application Publication
(10) Pub. No.: US 2006/0067214 A1
(43) Pub. Date: Mar. 30, 2006

(54) Systems and methods to select access points on wireless networks with quality of service functionality

(76) Inventor: Lakshmi Ramachandran, Bangalore (IN)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/951,862

(22) Filed: Sep. 27, 2004

(51) Int. Cl. H04Q 7/00; H04L 12/26; H04L 1/00; H04J 3/14; H04J 1/16

(52) U.S. Cl. 370/229; 370/328

(57) ABSTRACT

A client node selects an access point that can service its current and future bandwidth requirements. The client node locates one or more access points that are within range of the client node. The client node tests the located access points to determine which of them can handle its current bandwidth requirement. For the access points that can handle the current bandwidth requirement, the client node tests them to determine which can substantially handle its future bandwidth requirement. If one is found, the client node connects to that access point. Otherwise the client node connects to an access point that can at least handle its current bandwidth requirement.

### BACKGROUND

In a conventional wireless infrastructure network, each client node (e.g., a mobile station such as a laptop computer with a wireless connection) is associated with a wireless access point (AP) within a basic service set. There may be multiple wireless access points within range of an active client node, and the client node may periodically receive beacon frames from these multiple APs. Client nodes can also actively scan for APs that are within range by sending probes. When the available APs are detected, the client node can select a AP to associate with by sending the appropriate messages.

If the client node is running multimedia applications, Quality of Service (QoS) functionality may be used to optimize the performance of these applications within the wireless network. QoS allows an AP to prioritize traffic and optimize the way shared network resources are allocated among different applications. Without QoS functionality, all applications running on different client nodes have equal opportunity to transmit data frames. While that may work well for data traffic from applications such as web browsers, file transfers, or e-mail, this is inadequate for multimedia applications. Multimedia applications such as Voice over Internet Protocol (VoIP), video streaming, and interactive gaming are highly sensitive to latency increases and throughput reductions, and therefore require QoS functionality for the most favorable performance.

A multimedia application using QoS functionality may still present a poor user experience if the client node it is running on endures frequent hand offs across several APs. A hand off is the process of moving the client node from one AP to another, and this often occurs because of physical movement of the client node or because a new application is started on the client node with QoS requirements that cannot be met by the current AP. Frequent hand offs of the client node may result in a poor user experience because of the overheads associated with a hand off. It is desirable to allow a client node with a certain number of active flows to be able to start several applications over a period of time without triggering a burdensome amount of hand offs.

### BRIEF DESCRIPTION OF THE DRAWINGS

FIG. 1 is an implementation of a wireless network infrastructure.

FIG. 2 is one implementation of a user profile in accordance with the invention.

FIG. 3 is a method for selecting a wireless access point in accordance with the invention.

FIG. 4 is another method for selecting a wireless access point in accordance with the invention.

### DETAILED DESCRIPTION

The following description, various aspects of the illustrative implementations will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative implementations. However, it will be apparent to one skilled in the art that the present invention may be practiced without the specific details. In other instances, well-known circuits, structures and techniques have not been shown in detail in order not to obscure an understanding of this description.

References to “one implementation, an implementation”, “example implementation”, “various implementations”, etc., indicate that the implementation(s) of the invention so described may include a particular feature, structure, or characteristic, but not every implementation necessarily includes the particular feature, structure, or characteristic. Further, the different implementations described may have some, all, or none of the features described for other implementations.

In the following description and claims, the terms “coupled” and “connected,” along with their derivatives, may be used. It should be understood that these terms are not intended as synonyms for each other. Rather, in particular implementations, “connected” may be used to indicate that two or more elements are in direct physical or electrical contact with each other. “Coupled” may mean that two or more elements co-operate or interact with each other, but they may or may not be in direct physical or electrical contact.

The term “processor” may refer to any device or portion of a device that processes electronic data from registers and/or memory to transform that electronic data into other electronic data that may be stored in registers and/or memory. A “computing platform” may comprise one or more processors.

The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some implementations they might not.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner. Various operations will be described as multiple discrete operations, in turn, in a manner that is most helpful in understanding the present invention, however, the order of description should not be construed to imply that these operations are necessarily order dependent. In particular, these operations need not be performed in the order of presentation.

The invention provides novel Quality of Service (QoS) and user mobility based methods for wireless access point (AP) selection. The methods of the invention enable a mobile wireless client, referred to herein as a client node, to dynamically select the AP and maximize the number of users while reducing the number of hand offs because of resource constraints. The hand off may occur because the second AP has become more proximate to the client node than the first AP or the second AP has more bandwidth available for the client node than the first AP.

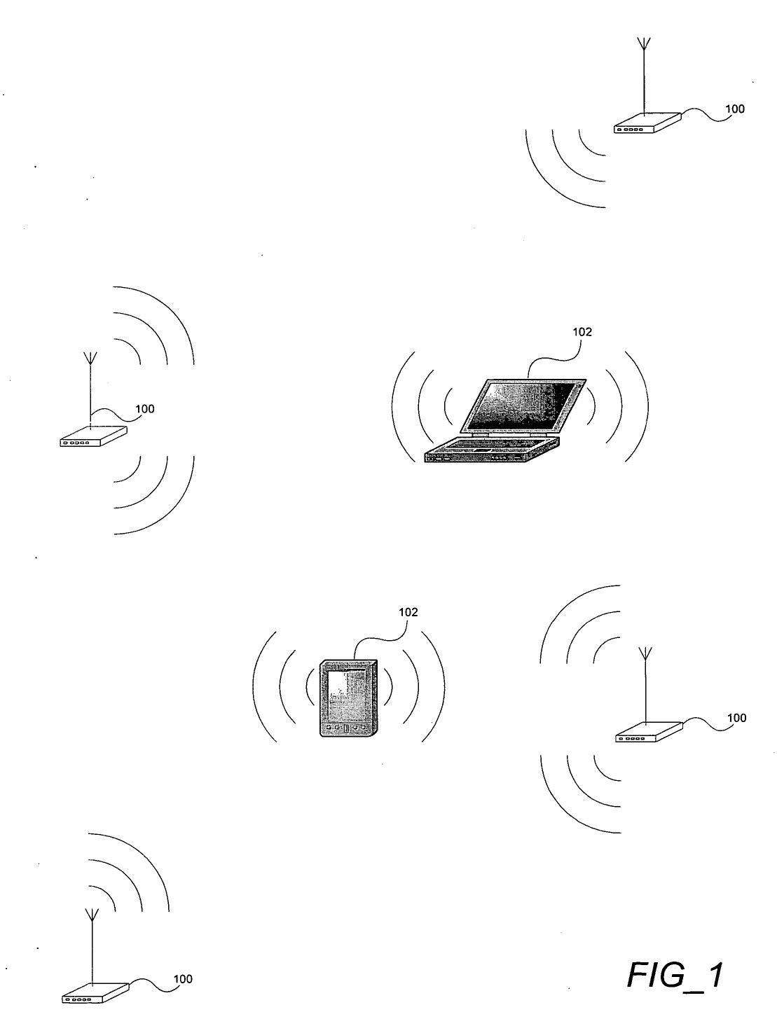

FIG. 1 illustrates a wireless network infrastructure with multiple APs 100 and multiple client nodes 102. In some implementations of the invention, the client nodes 102 may include, but are not limited to, devices such as laptop computers, notebook computers, mobile telephones, personal digital assistants (PDAs), and other devices that can communicate on a wireless network. In some implementations of the invention, the wireless infrastructure network may use radio frequency (RF) technology to implement the wireless network.

Within the wireless infrastructure network, each client node 102 may be serviced by an AP 100. The client node 102 may periodically receive beacon frames from one or more APs 100. The client node 102 may also actively scan for one or more APs 100 by sending probes. As is known in the art, the client node 102 may choose an AP 100 to connect to by sending appropriate messages. The client node 102 and APs 100 that implement QoS functionality may use additional information as part of their negotiation. This is to ensure that the bandwidth and/or delay requirements of applications (i.e., software programs) on the client node 102 may be met by the AP 100, which is particularly important for applications such as voice and video which have stringent packet delay requirements.

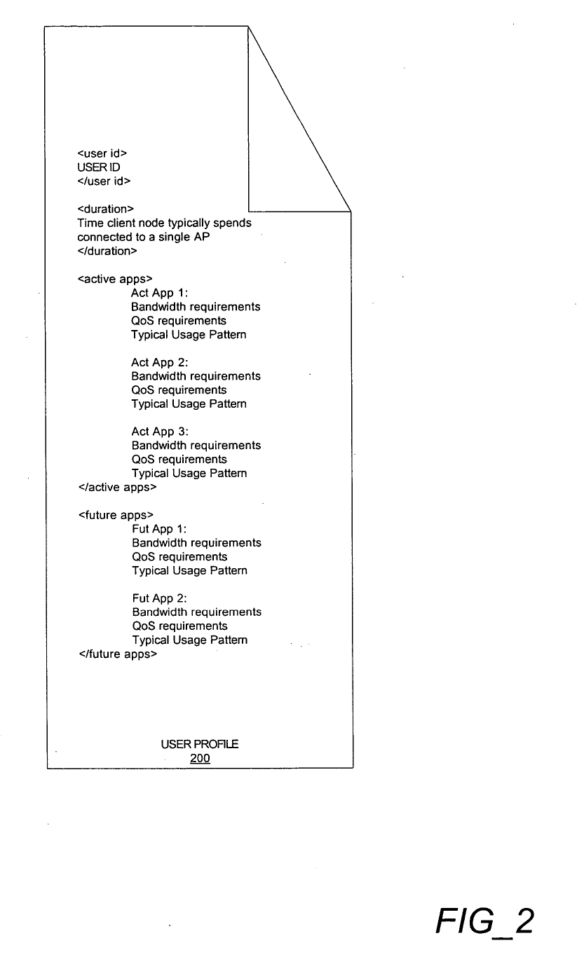

FIG. 2 illustrates one implementation of a user profile 200 in accordance with the invention. The user profile 200 may be a data file that is be used by the AP 100 to determine whether the AP 100 has enough available bandwidth to service the client node 102. The user profile 200 may be stored in a variety of available data formats that include, but are not limited to, extensible mark-up language (XML), hypertext mark-up language (HTML), Microsoft Word® format (.doc files), or Microsoft Excel® format (.xls files). In other implementations, data formats other than the ones provided herein may be used.

In some implementations, the user profile 200 may include roaming and usage patterns for the client node 102. For example, in one implementation the user profile 200 may include information that describes the types of applications that generally run on the client node 102, the QoS characteristics for each application, and the expected usage of each application. The expected usage may include the amount of time that each application is generally run on the client node 102 and may be described in terms of the number and type of data traffic flows. The user profile 200 may also indicate the amount of time that the client node 102 is generally connected to an AP 100. Some or all of the information included in the user profile 200 may influence the QoS requirements of the client node 102 and may be used to determine the probability of a hand off due to overloading of the AP 100.

In some implementations of the invention, the user profile 200 may be configurable by a user. For example, the user may configure the user profile 200 using a management application through a graphical user interface. In some implementations, the roaming pattern or typical roam duration of the client node 102 may be a parameter that is set by the user through the management application at the client node 102. Application usage patterns and bandwidth patterns may be set by the user as well, and these parameters may include the QoS requirements of the applications running on the client node 102.

In some implementations, the client node 102 may monitor and record the roaming patterns and application usage patterns. For example, the client node 102 may include monitoring software that is dedicated to monitoring and recording the roaming patterns and usage patterns of the client node 102. The monitoring software may use the recorded information to provide an estimate of the roaming and usage patterns of the client node 102. The recorded information may be inserted into the user profile 200, thereby eliminating the need for a user to manually set parameters in the user profile 200 using a management application.

Applications that run on the client node 102 may be categorized as active applications or future applications. Active applications are programs that are running when the client node 102 connects to the AP 100. Future applications are programs that are not running when the client node 102 connects to the AP 100, but may be started while the client node 102 is connected to the AP 100. In an implementation, the user profile 200 may include descriptions of both active applications and future applications for the client node 102. The categorization of an application as an active or future application may be taken into consideration when determining whether the AP 100 has bandwidth available for the client node 102.

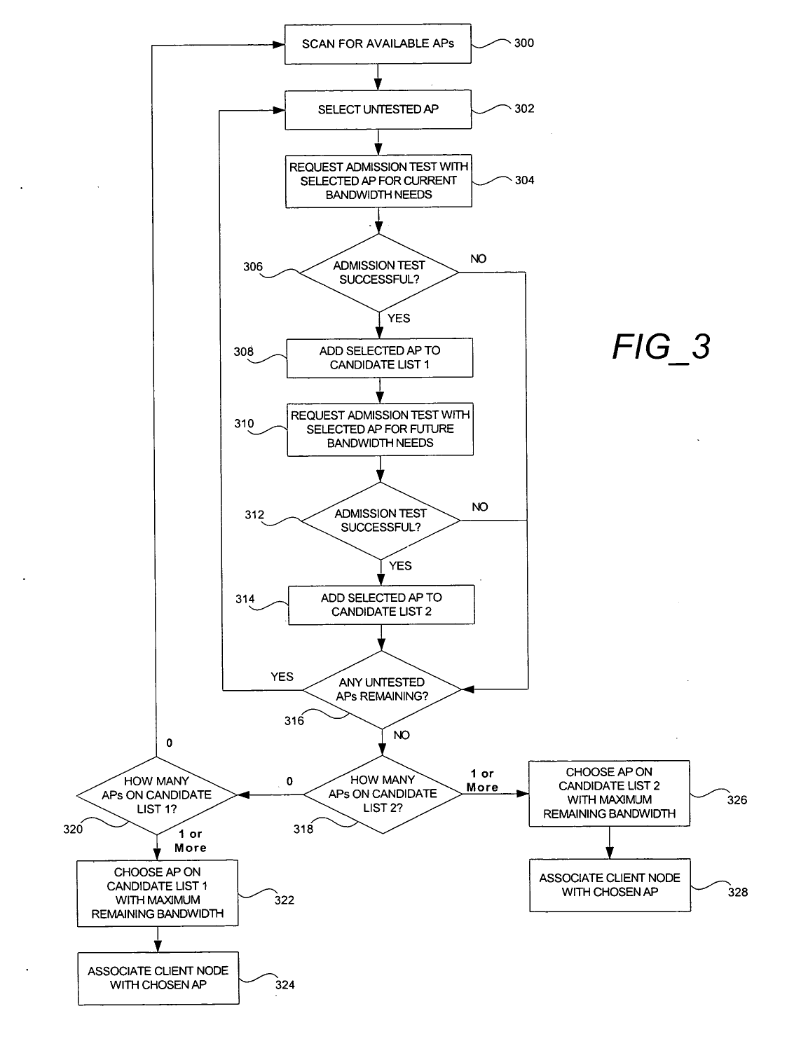

FIG. 3 is a method for selecting the preferred AP to reduce hand offs of the client node in accordance with one implementation of the invention. The method shown in FIG. 3 may be used, for example, by a client node when it has powered up or when it has moved into a coverage area for one or more APs. The client node may have a set of active application programs running on it and the APs within range may already be servicing other client nodes. The client node begins by scanning for all available APs within range (300). In one implementation, the client node may perform the scan passively by receiving beacon frames from all APs that are within range. In another implementation, the client node may perform the scan actively by transmitting probes out to all APs that are within range. In some implementations, alternate methods of locating available APs may be used. The process of scanning for an available AP may repeat until at least one available AP is found.

All of the APs detected by the client node may be tested to determine whether they have bandwidth available to handle at least the active applications running on the client node. From the available APs, the client node selects one AP that has not been tested (302). The client node requests that an admission test be performed on the selected AP based on the current bandwidth needs of the client node (i.e., the bandwidth requirements of the active applications running on the client node) (304). In some implementations, the client node may send a request to the AP asking for specific QoS parameter values for a call or session. In some implementations, the wireless network infrastructure may use an RF protocol that defines the messages and parameters that the client node and the AP may use for the negotiation.

The AP performs the admission test and notifies the client node as to whether the test was successful or unsuccessful. The results of the admission test may be based on factors such as how many calls the AP is already handling and whether the AP will be able to provide the necessary bandwidth required by the client node for its active applications. The admission test is successful if the necessary bandwidth is available. The admission test is unsuccessful if the necessary bandwidth is unavailable.

In some implementations, the AP may look at the information in the user profile of the client node to determine whether the AP has enough bandwidth available to service the active applications on the client node. As described above, the user profile may include information regarding the roaming patterns and application usage patterns of the client node. This information may be received and used by the AP as part of the admission test.

The algorithms or methods used by the admission test may vary from one AP to the next. In some implementations, it may be the vendor or the service provider associated with a particular AP that is responsible for installing and configuring the admission test.

The complexity of the admission test may vary as well. In some implementations, the admission test may use a simple method where the AP has a blanket limit on the number of voice calls it may handle. If the application profile of the client node includes a voice call and the AP has reached its limit for voice calls, the admission test may be unsuccessful.

In some implementations, the admission test may be more complex. For instance, in some implementations the admission test may include various types of channel access functions. One such function is enhanced distributed channel access (EDCA) and another such function is hybrid coordinated channel access (HCCA). The EDCA scheme is a prioritized channel access function that uses traffic classes with different predefined priorities. The traffic categories may include voice, video, best effort, and background traffic. Data flows belonging to higher priority traffic classes may have smaller contention windows and inter-frame spacing than data flows with lower priority traffic classes. This grants access to the wireless medium more often for higher priority traffic classes. The HCCA scheme is a centralized scheduling mechanism. Using HCCA, the AP may have a schedule for all of the client nodes associated with it, and the AP may poll the client nodes to give them a chance to transmit data.

The AP performs the admission test and the result of the admission test may be transmitted to the client node (306). If the admission test is unsuccessful, the client node may check to see whether there are untested APs remaining from which it can request admission tests (316). If there are any untested APs remaining, the client node may select another untested AP (302) and again request that an admission test be performed (304). If the admission test is successful, the client node may add the identity of the AP to a first candidate set (308). The first candidate set therefore contains the identities of APs that have bandwidth available for at least the active applications on the client node.

In some implementations, the APs included in the first candidate set need to be tested to determine whether they have bandwidth available to handle future applications that may be started on the client node. Therefore, when an AP is added to the first candidate set, the client node requests an admission test from that AP based on the future bandwidth needs of the client node (i.e., the bandwidth requirements of applications that are not currently active but will be started while the client node is connected to the AP) (310). The admission test performed for the future applications may be similar to the admission tests described above.

The AP performs the admission test for the future applications and the result is transmitted to the client node (312). If the admission test is unsuccessful, the client node may determine whether there are any untested APs from which it can request admission tests (316). If there are untested APs remaining, the client node may select another untested AP (302) and again request that an admission test be performed for the active applications on the client node (304).

If the admission test is successful, the client node may add the identity of the AP to a second candidate set (314). The second candidate set contains the identities of APs that have bandwidth available for active applications on the client node as well as future applications that may be started on the client node. After the AP is added to the second candidate set, the client node determines whether there are any untested APs remaining (316).

In some implementations of the invention, when all of the available APs have been tested and no untested APs remain, the client node may determine whether any of the available APs were added to the second candidate set (318). If the second candidate set includes the identities of one or more available APs, the client node chooses the AP from the second candidate set that has the maximum amount of bandwidth available (326). The chosen AP is the best available AP and the client node may then connect to this AP (328). In accordance with the invention, the chosen AP may have the lowest probability of handing off the client node due to it not being able to handle the active and future applications of the client node.

If the second candidate set is empty, there are no APs within range of the client node that are able to accommodate its future applications. The client node may therefore determine whether any available APs were added to the first candidate set (320). As described above, the first candidate set includes APs that have bandwidth available for the active applications on the client node but not the future applications.

If the first candidate set is empty, there are no APs within range of the client node that are even able to accommodate its active applications. The client node may then begin the entire process over by scanning for available APs within range (300). If, however, the first candidate set includes the identities of one or more available APs, the client node may choose the AP from the first candidate set that has the maximum amount of bandwidth available (322). The client node may then connect to the chosen AP (324).

Since there may be no APs within range that are able to accommodate the future applications of the client node, the client node may choose an AP based on it having the greatest amount of available bandwidth. The chosen AP may therefore have more bandwidth available for future applications on the client node than any other APs within range of the client node. The chosen AP may therefore be able to service the client node for a longer period of time than other APs within range before it may hand off the client node.

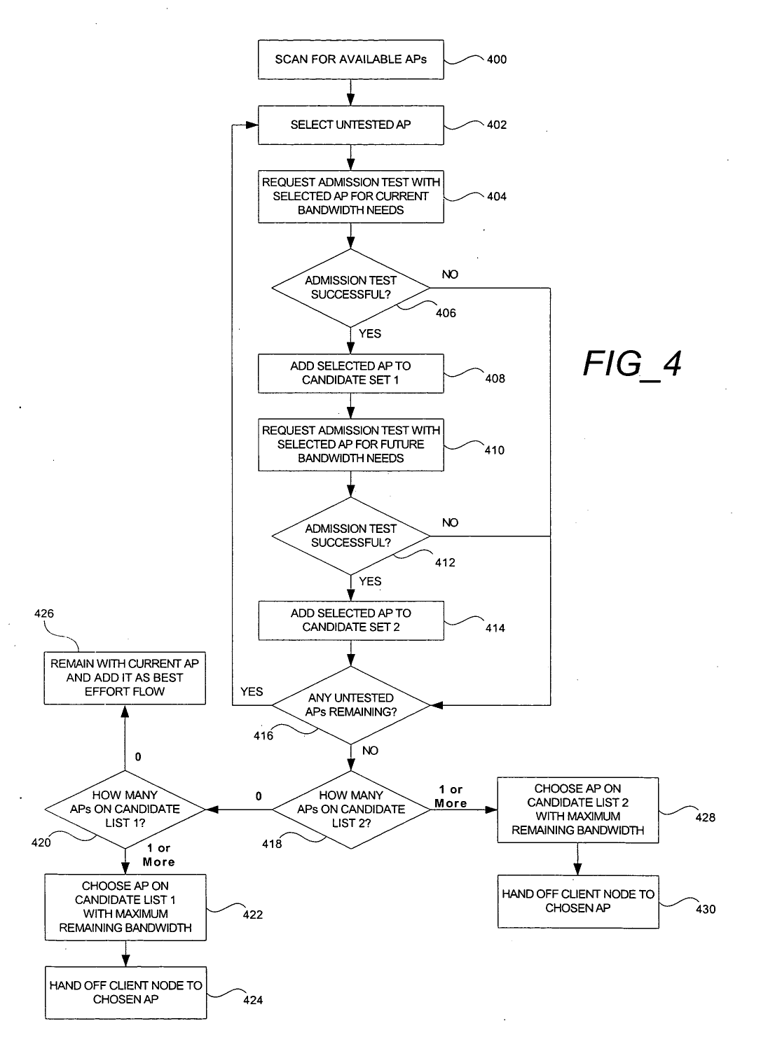

FIG. 4 illustrates another implementation of a method of the invention where the client node may be connected to an AP when it determines that it must connect to a new AP. This may occur because the client node launches one or more new applications (or attempts to launch them) and the QoS requirements of the new applications cannot be met by the original AP. The original AP must therefore hand off the client node, so the client node may first try to locate the best available AP to be handed off to. Locating the best available AP may minimize the probability of the client node being handed off again.

The client node begins its search for a new AP by scanning for all available APs within range (400). The original AP that is currently servicing the client node may be excluded from this search. When the client node has detected one or more available new APs, the client node selects one AP to test (402). The client node then requests an admission test from the selected AP based on its current bandwidth needs (404). The selected AP performs the admission test, as described above, and the client node receives a response from the AP (406). If the admission test is unsuccessful, the client node may look for a new AP to test (416). If the admission test is successful, the client node adds the selected AP to the first candidate set (408).

The client node may test the APs in the first candidate set to determine whether they can also handle the future applications of the client node. For each AP in the first candidate set, the client node requests an admission test based on its future bandwidth needs (410). The client node receives a response from each AP indicating whether that AP can handle the future applications (412). If the admission test is unsuccessful, the client node determines whether there are any more untested APs (416). If the admission test is successful, the client node includes the AP in the second candidate set (414).

When the client node has finished testing all of the available APs, the client node may determine whether there is at least one AP in the second candidate set (418). If the second candidate set includes one or more APs, the client node chooses the AP in the second candidate set that has the greatest amount of available bandwidth (428). The original AP then hands off the client node to the chosen AP (430).

If the second candidate set contains no APs, the client node determines whether the first candidate set includes any APs (420). If the first candidate set is empty, the client node remains associated with the original AP and adds it as a best-effort flow (426). A best-effort flow refers to treating the data flow like any other data traffic, therefore applications with QoS requirements receive no special treatment and the user experience may diminish. If, however, the first candidate set includes one or more APs, the client node chooses the AP in the first candidate set that has the greatest amount of available bandwidth (422). The original AP then hands off the client node to the chosen AP (424).

The methods and algorithms described herein may be distributed in nature. The algorithms may be performed at each client node, thereby conserving the limited resources of the APs. Distributing the work in this manner creates a system that tends to be more efficient and responsive. Furthermore, distributing the work means there is no centralized entity that has global knowledge of all client nodes.

The invention may be implemented in one or a combination of hardware, firmware, and software. The invention may also be implemented as instructions stored on a machine-readable medium, which may be read and executed by a processing platform to perform the operations described herein. A machine-readable medium may include any mechanism for storing, transmitting, or receiving information in a form readable by a machine (e.g., a computer). For example, a machine-readable medium may include read only memory (ROM); random access memory (RAM), such as dynamic random access memory (DRAM); magnetic disk storage media; optical storage media; flash memory devices; electrical, optical, acoustical or other form of propagated signals (e.g., carrier waves, infrared signals, digital signals, the interfaces that transmit and/or receive those signals, etc.), and others.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize.

These modifications may be made to the invention in light of the above detailed description. The terms used in the following claims should not be construed to limit the invention to the specific implementations disclosed in the specification and the claims. Rather, the scope of the invention is to be determined entirely by the following claims, which are to be construed in accordance with established doctrines of claim interpretation.

1. A method comprising:
defining a first set of access points, wherein each access point of the first set can substantially handle a current bandwidth requirement of a client node;
attempting to define a second set of access points that is a subset of the first set, wherein each access point of the second set can substantially handle a future bandwidth requirement of the client node; and
connecting to an access point of the second set if the second set is defined; else
connecting to an access point of the first set.

2. The method of claim 1, further comprising locating one or more access points that are within range of the client node.

3. The method of claim 2, wherein the defining of the first set of access points comprises:
requesting a first admission test from one or more access points that are located based on the current bandwidth requirement of the client node; and
including each access point with a successful first admission test in the first set.

4. The method of claim 3, wherein the attempting to define the second set of access points comprises:
requesting a second admission test from one or more access points of the first set based on the future bandwidth requirement of the client node; and
including each access point with a successful second admission test in the second set.

5. The method of claim 1, wherein the connecting to an access point of the second set comprises:
selecting an access point from the second set with the largest amount of available bandwidth; and
connecting to the selected access point.

6. The method of claim 1, wherein the connecting to an access point of the first set comprises:
selecting an access point from the first set with the largest amount of available bandwidth; and
connecting to the selected access point.

7. The method of claim 4, wherein the requesting a first admission test further comprises transmitting a user profile to the one or more access points that are located, wherein the user profile is used by each access point as part of the first admission test.

8. The method of claim 7, wherein the requesting a second admission test further comprises transmitting the user profile to the one or more access points of the first set, wherein the user profile is used by each access point as part of the second admission test.

9. The method of claim 8, wherein the user profile includes information regarding roaming patterns of the client node.

10. The method of claim 8, wherein the user profile includes information regarding usage patterns of the client node.

11. An article comprising a machine-readable medium that provides instructions, which when executed by a processing platform, cause said processing platform to perform operations comprising:
defining a first set of access points, wherein each access point of the first set can substantially handle a current bandwidth requirement of a client node;
attempting to define a second set of access points that is a subset of the first set, wherein each access point of the second set can substantially handle a future bandwidth requirement of the client node; and
connecting to an access point of the second set if the second set is defined; else
connecting to an access point of the first set.

12. The article of claim 11, wherein the operations further comprise locating one or more access points that are within range of the client node.

13. The article of claim 12, wherein the operation of defining the first set of access points comprises:
requesting a first admission test from one or more access points that are located based on the current bandwidth requirement of the client node; and
including each access point with a successful first admission test in the first set.

14. The article of claim 13, wherein the operation of attempting to define the second set of access points comprises:
requesting a second admission test from one or more access points of the first set based on the future bandwidth requirement of the client node; and
including each access point with a successful second admission test in the second set.

15. The article of claim 11, wherein the operation of connecting to an access point of the second set comprises:
selecting an access point from the second set with the largest amount of available bandwidth; and
connecting to the selected access point.

16. The article of claim 11, wherein the operation of connecting to an access point of the first set comprises:
selecting an access point from the first set with the largest amount of available bandwidth; and
connecting to the selected access point.

17. The article of claim 14, wherein the operation of requesting a first admission test further comprises transmitting a user profile to the one or more access points that are located, wherein the user profile is used by each access point as part of the first admission test.

18. The article of claim 17, wherein the operation of requesting a second admission test further comprises transmitting the user profile to the one or more access points of the first set, wherein the user profile is used by each access point as part of the second admission test.

19. The article of claim 18, wherein the user profile includes information regarding roaming patterns of the client node.

20. The article of claim 18, wherein the user profile includes information regarding usage patterns of the client node.

21. A wireless communication apparatus comprising:
a memory; and
a software application residing in the memory that provides instructions, which when executed by a processor, cause the processor to perform operations comprising:
defining a first set of access points, wherein each access point of the first set can substantially handle a current bandwidth requirement of a client node;
attempting to define a second set of access points that is a subset of the first set, wherein each access point of the second set can substantially handle a future bandwidth requirement of the client node; and
connecting to an access point of the second set if the second set is defined; else
connecting to an access point of the first set.

22. The apparatus of claim 21, wherein the operations further comprise locating one or more access points that are within range of the client node.

23. The apparatus of claim 22, wherein the operation of defining the first set of access points comprises:
requesting a first admission test from one or more access points that are located based on the current bandwidth requirement of the client node; and
including each access point with a successful first admission test in the first set.

24. The apparatus of claim 23, wherein the operation of attempting to define the second set of access points comprises:
requesting a second admission test from one or more access points of the first set based on the future bandwidth requirement of the client node; and
including each access point with a successful second admission test in the second set.

25. The apparatus of claim 21, wherein the operation of connecting to an access point of the second set comprises:
selecting an access point from the second set with the largest amount of available bandwidth; and
connecting to the selected access point.

26. The apparatus of claim 21, wherein the operation of connecting to an access point of the first set comprises:
selecting an access point from the first set with the largest amount of available bandwidth; and
connecting to the selected access point.

27. The apparatus of claim 24, wherein the operation of requesting a first admission test further comprises transmitting a user profile to the one or more access points that are located, wherein the user profile is used by each access point as part of the first admission test.

28. The apparatus of claim 27, wherein the operation of requesting a second admission test further comprises transmitting the user profile to the one or more access points of the first set, wherein the user profile is used by each access point as part of the second admission test.

29. The apparatus of claim 28, wherein the user profile includes information regarding roaming and/or usage patterns of the client node.

30. The apparatus of claim 28, wherein the memory comprises a DRAM memory.
